(19) United States
(12) Patent Application Publication
(10) Pub. No.: US 2017/0178287 A1
(43) Pub. Date: Jun. 22, 2017

(54) IDENTITY OBFUSCATION

(71) Applicant: Glen J. Anderson, Beaverton, OR (US)

(72) Inventor: Glen J. Anderson, Beaverton, OR (US)

(21) Appl. No.: 14/976,756

(22) Filed: Dec. 21, 2015

(51) Int. Cl. G06T 3/00; G06K 9/00

(52) U.S. Cl. CPC G06T 3/0093; G06K 9/00302; G06K 9/00228

(57) ABSTRACT

Various systems and methods for implementing identity obfuscation are described herein. A video processing system for obfuscating identity in visual images includes a data interface to access a source video having a human subject; an emotion classifier to determine an emotion exhibited by a face of the human subject; a skin classifier to detect areas of exposed skin of the human subject; and a video rendering module to render an output video with the face and the areas of exposed skin obscured, the face obscured with an expressive avatar exhibiting an expression similar to the emotion exhibited by the human subject.

### TECHNICAL FIELD

Embodiments described herein generally relate electronic vision processing, and in particular, to identity obfuscation.

### BACKGROUND

Video footage is becoming increasingly used by news outlets, law enforcement officers, and private citizens. In many cases, a media release form is needed to publish a picture or video of a person. To deal with the situation where there is no media release on file, media producers often blur or mask people's faces.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a diagram illustrating a face with landmark points, according to an embodiment;

FIG. 2 is a diagram illustrating expressive avatars that correspond to the six standard emotions, according to an embodiment;

FIG. 3 is a diagram illustrating a composite image with an expressive avatar masking the person's face, according to an embodiment;

FIG. 4 is a diagram illustrating a composite image where the skin around the neck and chin replaced with a black mask, according to an embodiment;

FIG. 5 is an illustration where the person's head hair is masked using a black mask, according to an embodiment;

FIG. 6 is a block diagram illustrating video processing system for obfuscating identity in visual images, according to an embodiment;

FIG. 7 is a flowchart illustrating a method of obfuscating identity in visual images, according to an embodiment; and

FIG. 8 is a block diagram illustrating an example machine upon which any one or more of the techniques (e.g., methodologies) discussed herein may perform, according to an example embodiment.

### DETAILED DESCRIPTION

In the following description, for purposes of explanation, numerous specific details are set forth in order to provide a thorough understanding of some example embodiments. It will be evident, however, to one skilled in the art that the present disclosure may be practiced without these specific details.

Systems and methods described herein provide identity obfuscation. In various situations, a media producer obscures a person's face in a video. As an example, the collection of video footage from police cameras (e.g., body cams) is increasing rapidly. Body cams are popular due to a desire to document interactions with suspects, witnesses, and others. Benefits of body cams include reducing the escalation of violence by both law enforcement officers and suspects, ensuring proper process is followed (e.g., during an arrest or interrogation), and documenting the environment during an interaction with the public.

In the case of media recording in general, and body cams in specific, personal privacy is essential. With body cams, videos may capture innocent bystanders who may not want their details distributed or shared. In videos that have faces obscured, other aspects of the person may still be visible. Unfortunately, many viewers may have racial or other biases. As such, facial obfuscation alone may not remove all aspects of identity that may unfairly influence judgements. For some usages, such as an initial review of video evidence or public distribution of police video, removing additional cues about identity may allow for more fair and just judgements.

There are some software applications that allow media editors to obscure faces with mosaics, Gaussian blurs, black blocks, or the like. However, obscuring the face may result in a loss of contextual information, such as the expressions of emotion. In addition, while facial obfuscation may reduce the possibility of a positive identification, it does not completely remove all identifying features.

The present disclosure provides a mechanism to serve the privacy interests of video subjects while also preserving contextual information. In general, systems and methods provided herein may be configured to collect data to allow determination of emotion, context, and other behaviors of a subject before removing identifiable information. Additional video processing may be performed to identify the subject's skin tone. Subsequently, avatar-like information is inserted to obscure the subject's face and additional masking is used to obscure the subject's skin tone. To further serve privacy interests, in some embodiments, a subject's voice may be obscured as well.

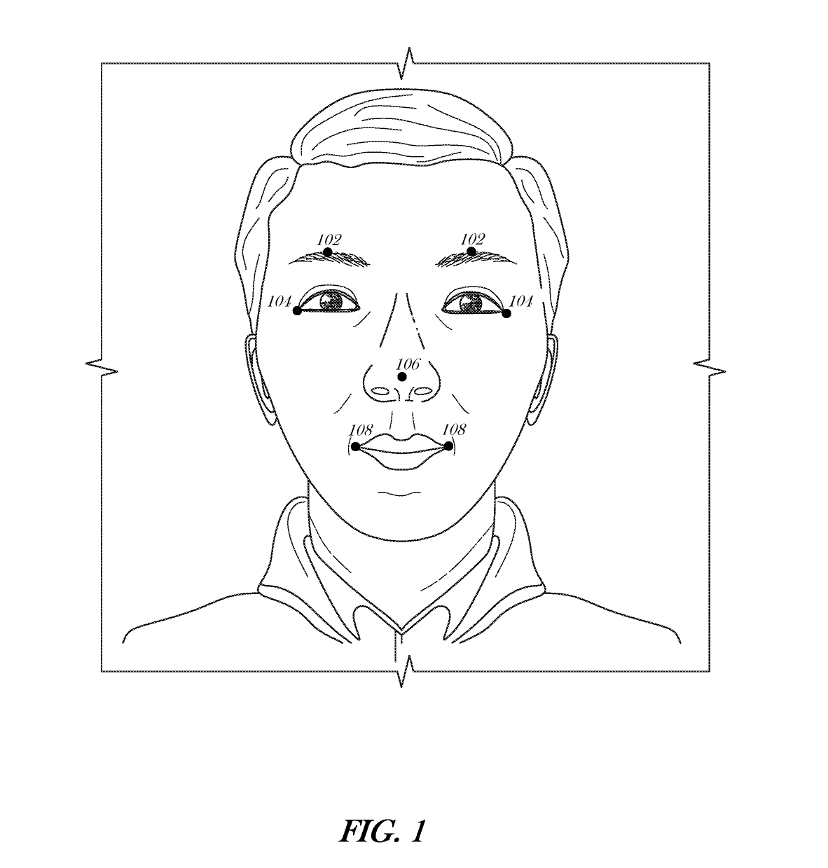

FIG. 1 is a diagram illustrating a face 100 with landmark points, according to an embodiment. The face 100 includes multiple landmark points, including points on an eyebrow 102 (e.g., middle of brow), an eye 104 (e.g., outer edge of eye), a nose 106 (e.g., tip of nose), and a mouth 108 (e.g., outside edges of mouth). Although only a few landmark points are illustrated in FIG. 1, it is understood that many more may be present and used by facial analysis programs to determine landmark position. Examples of additional landmarks include, but are not limited to an outer edge of brow, middle of brow, inner edge of brow, outside edge of eye, midpoints on eye, inside edge of eye, bridge of nose, lateral sides of nose, tip of nose, outside edges of mouth, left and right medial points on upper lip, center of upper lip, left and right medial points on lower lip.

Based on the position of the landmarks (e.g., 102, 104, 106, 108, etc.) or the position over time of the landmarks, an expression or emotion may be determined. For example, a sequence of facial expressions may be recognized and detected as a specific movement pattern of the landmark. An emotion classifier may be trained to recognize the emotions of anger, disgust, fear, happiness, sadness, and surprise as set forth in the Facial Action Coding System (FACS), and the additional sub-divisions of “happiness” into the smile-related categories of joy, skepticism (a/k/a false smile), micro-smile, true smile, and social smile.

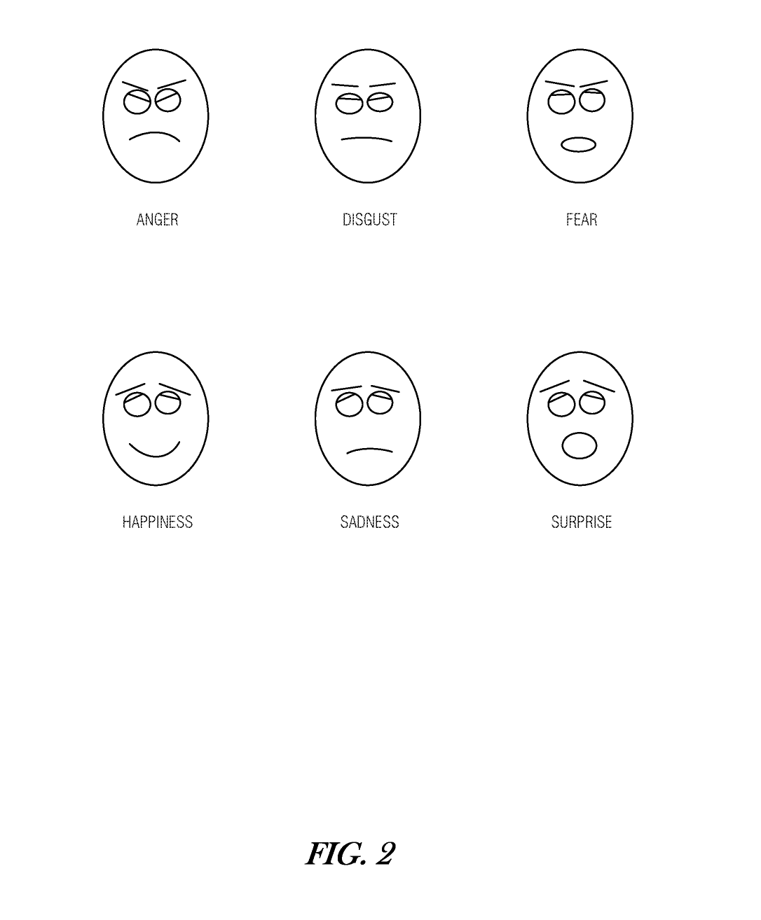

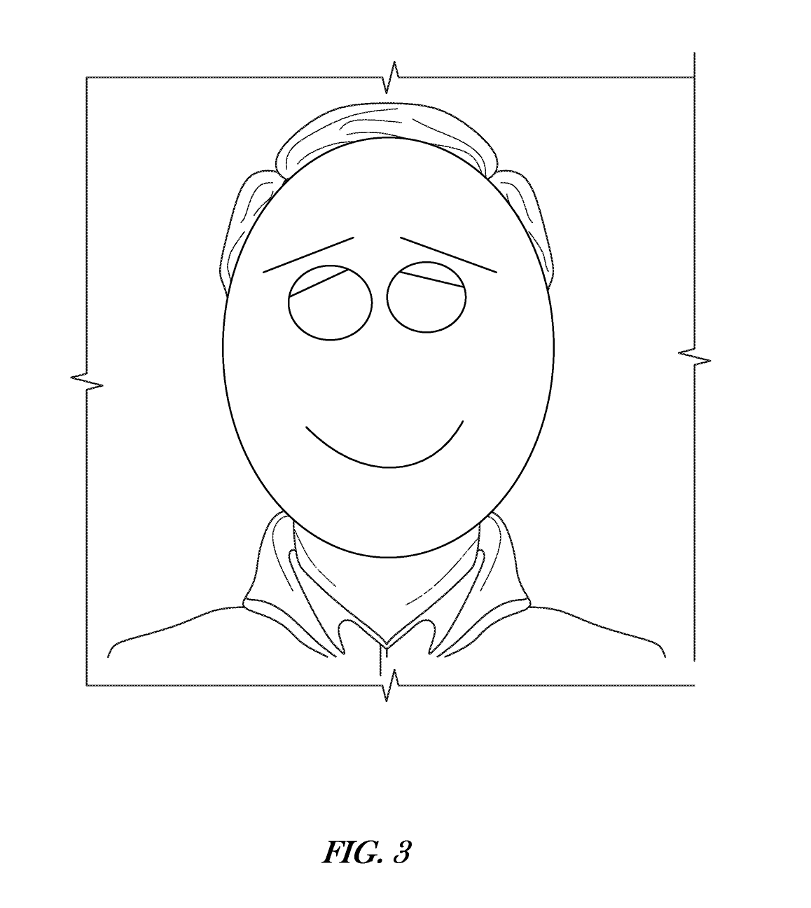

Based on the emotional classification, an avatar may be selected from a database of avatars. The selected avatar is chosen as one that has an expression that closely resembles that of the emotional classification. FIG. 2 is a diagram illustrating expressive avatars that correspond to the six standard emotions. It is understood that additional expressive avatars may be designed to represent additional emotions, such as the happiness sub-divisions. Other expressive avatars may be used to convey the emotional states of confusion, shame, exhaustion, neutral, annoyed, bored, etc. FIG. 3 is a diagram illustrating a composite image with an expressive avatar masking the person's face, according to an embodiment. While the person's identity is obscured, it is seen that the person's general emotion is represented via the expressive avatar. In the case of a video, the person's emotions and expressions may change throughout the video, in which case the expressive avatar may be modified to correspond with the changing emotions/expressions. However, it is understood that while the avatar may illustrate the emotional state of the user, it does not track the facial characteristics of the user. Thus, the user's emotional state is determined with the complex hardware and software system in order to put a virtual “rubber mask” on the user.

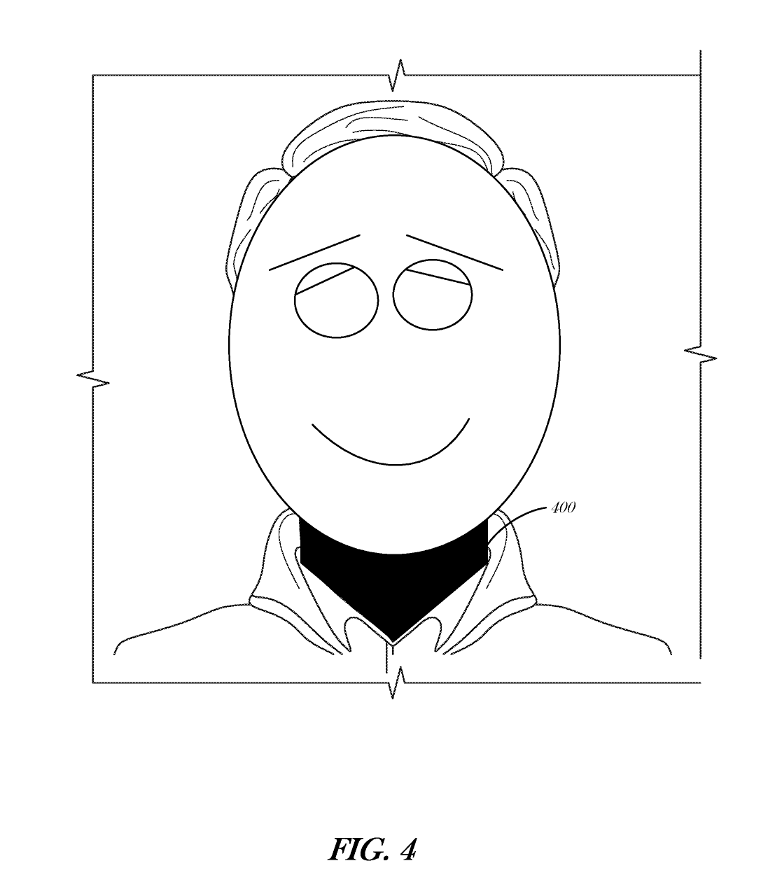

In addition to the face masking, as is illustrated in FIG. 4, the skin may also be obscured. The skin color may be used by some people either consciously or unconsciously to form a biased opinion of the situation depicted in an image of video. Obscuring the skin color may be useful to reduce or eliminate such bias. In the example illustrated in FIG. 4, the skin around the neck and chin is detected and replaced with a black mask 400. The mask may be of any color or pattern. The use of a color not of a typical skin tone may be preferred to avoid the bias that may otherwise be introduced.

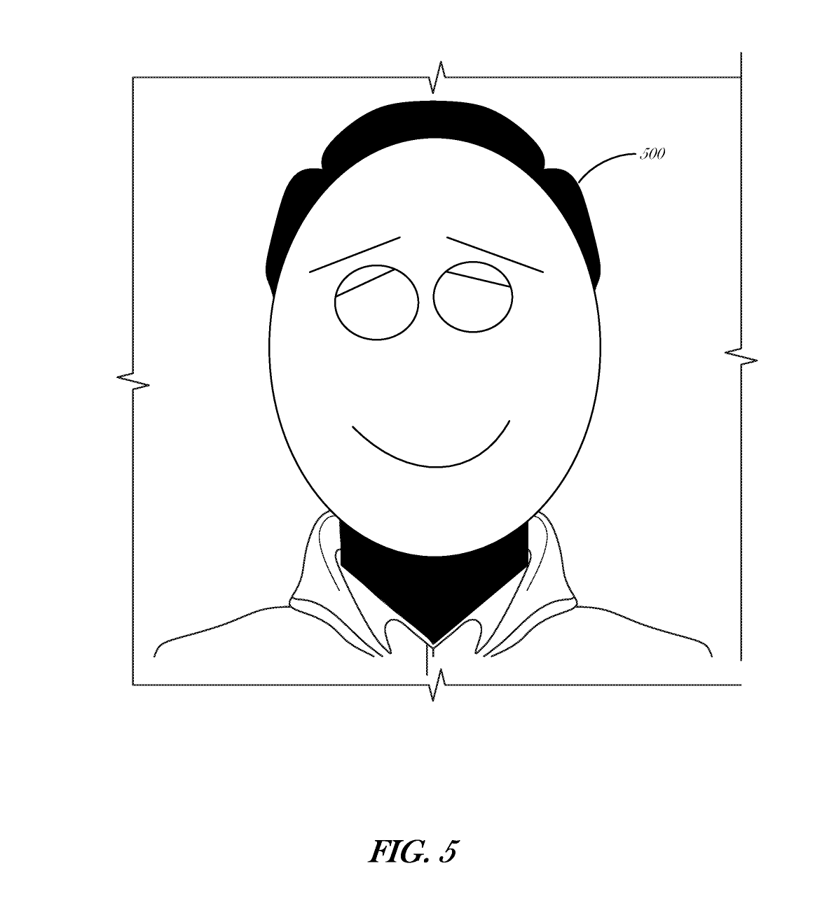

In addition to the face masking, and as an alternative or in addition to skin obfuscation, the person's head hair may also be masked to again reduce or eliminate racial or other biases. FIG. 5 is an illustration where the person's head hair is masked using a black mask 500, according to an embodiment. While the hair obfuscation illustrated in FIG. 5 roughly follows the same original hair outline, it is understood that any shape may be used to obfuscate the head hair, including irregular shapes that may obscure the hair style, texture, or type better than a direct overlay mask.

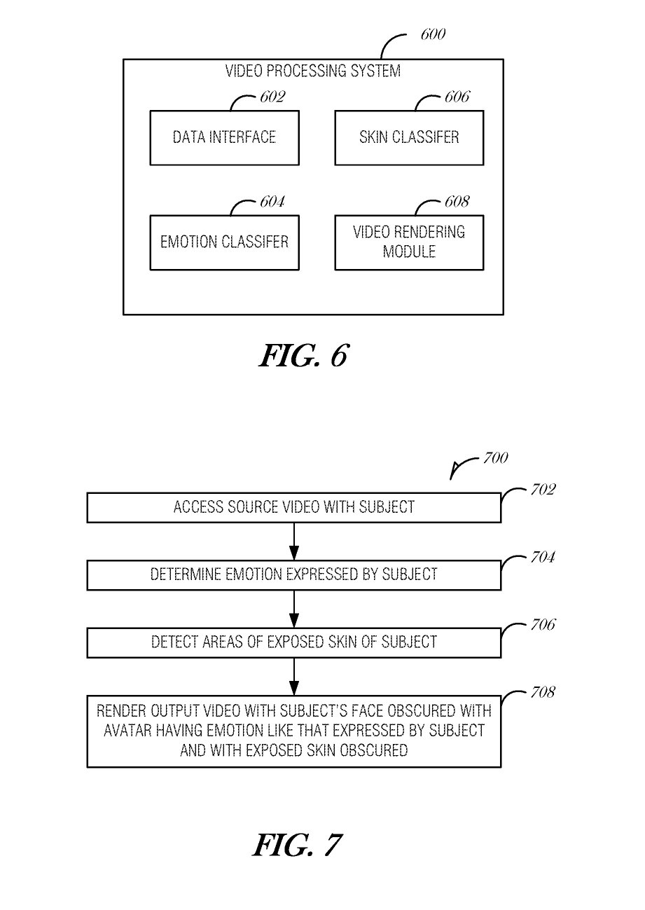

FIG. 6 is a block diagram illustrating video processing system 600 for obfuscating identity in visual images, according to an embodiment. The system 600 includes a data interface 602, an emotion classifier 604, a skin classifier 606, and a video rendering module 608.

The data interface 602 may be configured to access a source video having a human subject. The source video may be previously recorded, in which case the data interface 602 may obtain the source video from a storage device. Alternatively, the data interface 602 may access a video stream (e.g., broadcast), in which case the video rendering module 608 may dynamically compose a resultant video with appropriate obfuscation.

The emotion classifier 604 may be configured to determine an emotion exhibited by a face of the human subject. In an embodiment, to determine the emotion exhibited by the face, the emotion classifier 604 is to identify a plurality of facial landmarks in the face; access a facial emotion database; and classify the emotion exhibited based on the plurality of facial landmarks and the facial emotion database. Emotion classification may be conducted on a single video frame or image, or may be conducted over several successive frames to account for movement of one or more landmarks on the face.

The skin classifier 606 may be configured to detect areas of exposed skin of the human subject. In an embodiment, to detect areas of exposed skin, the skin classifier 606 is to sample a portion of an image obtained from the source video and determine whether the portion of the image is skin or non-skin. Skin classification may be performed by analyzing the portion of the image to determine a color space and then comparing the portion against a database of skin tones in a given color space. A skin classifier may define decision boundaries of skin colors in the color space based on a training database of skin-colored pixels. The skin classifier 606 may be trained using such a mechanism. The skin classifier 606 may be further trained to account for variations in illumination conditions, skin coloration variation, skin-colored clothing, morphology, and the like.

The video rendering module 608 may be configured to render an output video with the face and the areas of exposed skin obscured, the face obscured with an expressive avatar exhibiting an expression similar to the emotion exhibited by the human subject. For example, the video rendering module 608 may overlay the expressive avatar and maintain its relative position on the subject's face during the duration of the video. In addition, the video rendering module 608 may adjust skew, position, tilt, and other aspects of the expressive avatar to correlate with the subject's head position (e.g., while turning their head, bowing their head, etc.).

Skin obfuscation may be of any type of video overlay, such as solid blocks that form to the actual outline of the subject's body, color fills that only roughly conform to the outline of the subject's body, patterned fills, etc.

In an embodiment, the video processing system 600 includes a hair classifier to detect head hair of the human subject. In such an embodiment, to render the output video, the video rendering module 608 is to obscure the head hair. In a further embodiment, to obscure the head hair, the video rendering module 608 is to render the head hair in a solid color. It is understood that any type of masking or obfuscation may be used to obscure the head hair, such as, for example, patterned blocks, textured surfaces, solid colors, alternating colors, and the like.

In an embodiment, the data interface 602 is to access an infrared image of the human subject, the infrared image including an infrared representation of the areas of exposed skin of the subject. In such an embodiment, to render the output video, the video rendering module 608 is to render the areas of exposed skin with the infrared representation of the areas of exposed skin of the subject.

In an embodiment, to render the output video, the video rendering module 608 is to render the face of the subject with the infrared representation of the face of the subject. The infrared images may be obtained at the same time as the visible light video footage. Some cameras include sensory arrays to capture both types of footage simultaneously. Alternatively, the infrared footage may be derived from the original visible-light footage using a color filter or other post-capture video processing.

Infrared representations may provide another way to reduce the initial bias that may be felt when viewing a video. While preserving actual facial emotions, infrared imagery may obscure enough of the subject's identity to ensure that fairer viewing is allowed. Other embodiments include rendering the face and other exposed areas of skin in infrared.

In an embodiment, the data interface 602 is to access an audio portion of the source video, the audio portion including an audio recording of the human subject. In such an embodiment, to render the output video, the video rendering module 608 is to render the audio portion of the source video with a modified audio portion to obscure the audio recording of the subject. In a further embodiment, the modified audio portion is composed by altering a pitch of the audio recording of the human subject. In a further embodiment, the pitch is randomly altered over time. A random number generator may be used to determine a value using a seed (e.g., the current time). The value may then be altered over an acoustic range to provide a variability to the pitch of the subject's voice.

In some embodiments, the video processing system 600 may use a static expressive avatar for the entirety of a video. However, in other situations having an expressive avatar that approximates and corresponds with the subject's changing mood is useful to ensure that the viewer is provided as much contextual information as possible. Thus, in an embodiment, to render the output video with the face and the areas of exposed skin obscured, the video rendering module 608 is to alter the expressive avatar as the emotion exhibited by the face of the human subject changes in the source video.

FIG. 7 is a flowchart illustrating a method 700 of obfuscating identity in visual images, according to an embodiment. At block 702, a source video having a human subject is accessed at a video processing system.

At block 704, an emotion exhibited by a face of the human subject is determined.

At block 706, areas of exposed skin of the human subject are detected.

At block 708, an output video with the face and the areas of exposed skin obscured is rendered, the face obscured with an expressive avatar exhibiting an expression similar to the emotion exhibited by the human subject.

In an embodiment, determining the emotion exhibited by the face comprises identifying a plurality of facial landmarks in the face, accessing a facial emotion database, and classifying the emotion exhibited based on the plurality of facial landmarks and the facial emotion database.

In an embodiment, detecting areas of exposed skin comprises sampling a portion of an image obtained from the source video and using a skin classifier to determine whether the portion of the image is skin or non-skin.

In an embodiment, the method 700 includes detecting head hair of the human subject. In such an embodiment, rendering the output video comprises obscuring the head hair. In a further embodiment, obscuring the head hair comprises rendering the head hair in a solid color.

In an embodiment, the method 700 includes accessing an infrared image of the human subject, the infrared image including an infrared representation of the areas of exposed skin of the subject. In such an embodiment, rendering the output video comprises rendering the areas of exposed skin with the infrared representation of the areas of exposed skin of the subject.

In an embodiment, rendering the output video comprises rendering the face of the subject with the infrared representation of the face of the subject.

In an embodiment, the method 700 includes accessing an audio portion of the source video, the audio portion including an audio recording of the human subject. In such an embodiment, rendering the output video comprises replacing the audio portion of the source video with a modified audio portion to obscure the audio recording of the subject. In a further embodiment, the modified audio portion is composed by altering a pitch of the audio recording of the human subject. In a further embodiment, the pitch is randomly altered over time.

In an embodiment, rendering the output video with the face and the areas of exposed skin obscured comprises altering the expressive avatar as the emotion exhibited by the face of the human subject changes in the source video.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

A processor subsystem may be used to execute the instruction on the machine-readable medium. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

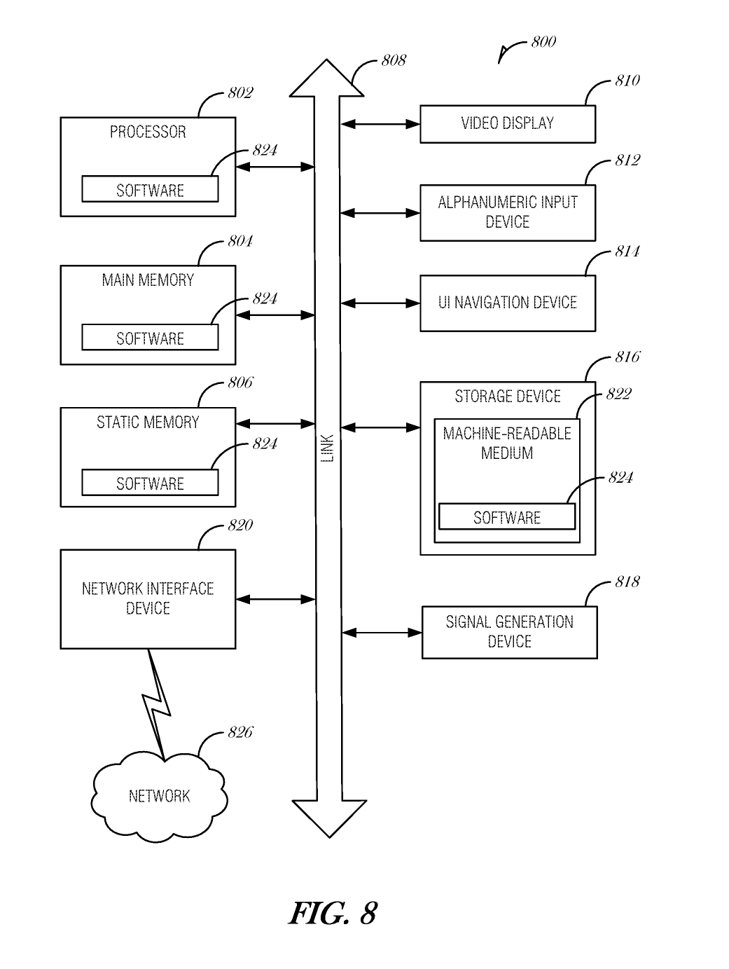

FIG. 8 is a block diagram illustrating a machine in the example form of a computer system 800, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an onboard vehicle system, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 800 includes at least one processor 802 (e.g., a central processing unit (CPU), a graphics processing unit (GPU) or both, processor cores, compute nodes, etc.), a main memory 804 and a static memory 806, which communicate with each other via a link 808 (e.g., bus). The computer system 800 may further include a video display unit 810, an alphanumeric input device 812 (e.g., a keyboard), and a user interface (UI) navigation device 814 (e.g., a mouse). In one embodiment, the video display unit 810, input device 812 and UI navigation device 814 are incorporated into a touch screen display. The computer system 800 may additionally include a storage device 816 (e.g., a drive unit), a signal generation device 818 (e.g., a speaker), a network interface device 820, and one or more sensors (not shown), such as a global positioning system (GPS) sensor, compass, accelerometer, or other sensor.

The storage device 816 includes a machine-readable medium 822 on which is stored one or more sets of data structures and instructions 824 (e.g., software) embodying or utilized by any one or more of the methodologies or functions described herein. The instructions 824 may also reside, completely or at least partially, within the main memory 804, static memory 806, and/or within the processor 802 during execution thereof by the computer system 800, with the main memory 804, static memory 806, and the processor 802 also constituting machine-readable media.

While the machine-readable medium 822 is illustrated in an example embodiment to be a single medium, the term “machine-readable medium” may include a single medium or multiple media (e.g., a centralized or distributed database, and/or associated caches and servers) that store the one or more instructions 824. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 824 may further be transmitted or received over a communications network 826 using a transmission medium via the network interface device 820 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

### ADDITIONAL NOTES & EXAMPLES

Example 1 is a video processing system for obfuscating identity in visual images, the system comprising: a data interface to access a source video having a human subject; an emotion classifier to determine an emotion exhibited by a face of the human subject; a skin classifier to detect areas of exposed skin of the human subject; and a video rendering module to render an output video with the face and the areas of exposed skin obscured, the face obscured with an expressive avatar exhibiting an expression similar to the emotion exhibited by the human subject.

In Example 2, the subject matter of Example 1 optionally includes, wherein to determine the emotion exhibited by the face, the emotion classifier is to: identify a plurality of facial landmarks in the face; access a facial emotion database; and classify the emotion exhibited based on the plurality of facial landmarks and the facial emotion database.

In Example 3, the subject matter of any one or more of Examples 1-2 optionally include, wherein to detect areas of exposed skin, the skin classifier is to: sample a portion of an image obtained from the source video; and determine whether the portion of the image is skin or non-skin.

In Example 4, the subject matter of any one or more of Examples 1-3 optionally include, further comprising a hair classifier to: detect head hair of the human subject; and wherein to render the output video, the video rendering module is to obscure the head hair.

In Example 5, the subject matter of Example 4 optionally includes, wherein to obscure the head hair, the video rendering module is to render the head hair in a solid color.

In Example 6, the subject matter of any one or more of Examples 1-5 optionally include, wherein the data interface is to access an infrared image of the human subject, the infrared image including an infrared representation of the areas of exposed skin of the subject; and wherein to render the output video, the video rendering module is to render the areas of exposed skin with the infrared representation of the areas of exposed skin of the subject.

In Example 7, the subject matter of any one or more of Examples 1-6 optionally include, wherein to render the output video, the video rendering module is to render the face of the subject with the infrared representation of the face of the subject.

In Example 8, the subject matter of any one or more of Examples 1-7 optionally include, wherein the data interface is to access an audio portion of the source video, the audio portion including an audio recording of the human subject; and wherein to render the output video, the video rendering module is to render the audio portion of the source video with a modified audio portion to obscure the audio recording of the subject.

In Example 9, the subject matter of Example 8 optionally includes, wherein the modified audio portion is composed by altering a pitch of the audio recording of the human subject.

In Example 10, the subject matter of Example 9 optionally includes, wherein the pitch is randomly altered over time.

In Example 11, the subject matter of any one or more of Examples 1-10 optionally include, wherein to render the output video with the face and the areas of exposed skin obscured, the video rendering module is to alter the expressive avatar as the emotion exhibited by the face of the human subject changes in the source video.

Example 12 is a method of obfuscating identity in visual images, the method comprising: accessing, at a video processing system, a source video having a human subject; determining an emotion exhibited by a face of the human subject; detecting areas of exposed skin of the human subject; and rendering an output video with the face and the areas of exposed skin obscured, the face obscured with an expressive avatar exhibiting an expression similar to the emotion exhibited by the human subject.

In Example 13, the subject matter of Example 12 optionally includes, wherein determining the emotion exhibited by the face comprises: identifying a plurality of facial landmarks in the face; accessing a facial emotion database; and classifying the emotion exhibited based on the plurality of facial landmarks and the facial emotion database.

In Example 14, the subject matter of any one or more of Examples 12-13 optionally include, wherein detecting areas of exposed skin comprises: sampling a portion of an image obtained from the source video; and using a skin classifier to determine whether the portion of the image is skin or non-skin.

In Example 15, the subject matter of any one or more of Examples 12-14 optionally include, further comprising: detecting head hair of the human subject; and wherein rendering the output video comprises obscuring the head hair.

In Example 16, the subject matter of Example 15 optionally includes, wherein obscuring the head hair comprises rendering the head hair in a solid color.

In Example 17, the subject matter of any one or more of Examples 12-16 optionally include, further comprising: accessing an infrared image of the human subject, the infrared image including an infrared representation of the areas of exposed skin of the subject; and wherein rendering the output video comprises rendering the areas of exposed skin with the infrared representation of the areas of exposed skin of the subject.

In Example 18, the subject matter of any one or more of Examples 12-17 optionally include, wherein rendering the output video comprises rendering the face of the subject with the infrared representation of the face of the subject.

In Example 19, the subject matter of any one or more of Examples 12-18 optionally include, further comprising: accessing an audio portion of the source video, the audio portion including an audio recording of the human subject; and wherein rendering the output video comprises replacing the audio portion of the source video with a modified audio portion to obscure the audio recording of the subject.

In Example 20, the subject matter of Example 19 optionally includes, wherein the modified audio portion is composed by altering a pitch of the audio recording of the human subject.

In Example 21, the subject matter of Example 20 optionally includes, wherein the pitch is randomly altered over time.

In Example 22, the subject matter of any one or more of Examples 12-21 optionally include, wherein rendering the output video with the face and the areas of exposed skin obscured comprises altering the expressive avatar as the emotion exhibited by the face of the human subject changes in the source video.

Example 23 is at least one machine-readable medium including instructions, which when executed by a machine, cause the machine to perform operations of any of the methods of Examples 12-22.

Example 24 is an apparatus comprising means for performing any of the methods of Examples 12-22.

Example 25 is an apparatus for obfuscating identity in visual images, the apparatus comprising: means for accessing, at a video processing system, a source video having a human subject; means for determining an emotion exhibited by a face of the human subject; means for detecting areas of exposed skin of the human subject; and means for rendering an output video with the face and the areas of exposed skin obscured, the face obscured with an expressive avatar exhibiting an expression similar to the emotion exhibited by the human subject.

In Example 26, the subject matter of Example 25 optionally includes, wherein the means for determining the emotion exhibited by the face comprise: means for identifying a plurality of facial landmarks in the face; means for accessing a facial emotion database; and means for classifying the emotion exhibited based on the plurality of facial landmarks and the facial emotion database.

In Example 27, the subject matter of any one or

more of Examples 25-26 optionally include, wherein the means for detecting areas of exposed skin comprises: means for sampling a portion of an image obtained from the source video; and means for using a skin classifier to determine whether the portion of the image is skin or non-skin.

In Example 28, the subject matter of any one or more of Examples 25-27 optionally include, further comprising: means for detecting head hair of the human subject; and wherein the means for rendering the output video comprise means for obscuring the head hair.

In Example 29, the subject matter of Example 28 optionally includes, wherein the means for obscuring the head hair comprise means for rendering the head hair in a solid color.

In Example 30, the subject matter of any one or more of Examples 25-29 optionally include, further comprising: means for accessing an infrared image of the human subject, the infrared image including an infrared representation of the areas of exposed skin of the subject; and wherein the means for rendering the output video comprise means for rendering the areas of exposed skin with the infrared representation of the areas of exposed skin of the subject.

In Example 31, the subject matter of any one or more of Examples 25-30 optionally include, wherein the means for rendering the output video comprise means for rendering the face of the subject with the infrared representation of the face of the subject.

In Example 32, the subject matter of any one or more of Examples 25-31 optionally include, further comprising: means for accessing an audio portion of the source video, the audio portion including an audio recording of the human subject; and wherein the means for rendering the output video comprise means for replacing the audio portion of the source video with a modified audio portion to obscure the audio recording of the subject.

In Example 33, the subject matter of Example 32 optionally includes, wherein the modified audio portion is composed by altering a pitch of the audio recording of the human subject.

In Example 34, the subject matter of Example 33 optionally includes, wherein the pitch is randomly altered over time.

In Example 35, the subject matter of any one or more of Examples 25-34 optionally include, wherein the means for rendering the output video with the face and the areas of exposed skin obscured comprise means for altering the expressive avatar as the emotion exhibited by the face of the human subject changes in the source video.

Example 36 is a system for obfuscating identity in visual images, the system comprising: a processor subsystem; and a memory including instructions, which when executed by the processor subsystem, cause the processor subsystem to: access a source video having a human subject; determine an emotion exhibited by a face of the human subject; detect areas of exposed skin of the human subject; and render an output video with the face and the areas of exposed skin obscured, the face obscured with an expressive avatar exhibiting an expression similar to the emotion exhibited by the human subject.

In Example 37, the subject matter of Example 36 optionally includes, wherein the instruction to determine the emotion exhibited by the face comprise instruction to: identify a plurality of facial landmarks in the face; access a facial emotion database; and classify the emotion exhibited based on the plurality of facial landmarks and the facial emotion database.

In Example 38, the subject matter of any one or more of Examples 36-37 optionally include, wherein the instruction to detect areas of exposed skin comprise instruction to: sample a portion of an image obtained from the source video; and use a skin classifier to determine whether the portion of the image is skin or non-skin.

In Example 39, the subject matter of any one or more of Examples 36-38 optionally include, further comprising instruction to: detect head hair of the human subject; and wherein the instruction to render the output video comprise instruction to obscuring the head hair.

In Example 40, the subject matter of Example 39 optionally includes, wherein the instruction to obscure the head hair comprise instruction to rendering the head hair in a solid color.

In Example 41, the subject matter of any one or more of Examples 36-40 optionally include, further comprising instruction to: access an infrared image of the human subject, the infrared image including an infrared representation of the areas of exposed skin of the subject; and wherein the instruction to render the output video comprise instruction to rendering the areas of exposed skin with the infrared representation of the areas of exposed skin of the subject.

In Example 42, the subject matter of any one or more of Examples 36-41 optionally include, wherein rendering the output video comprises rendering the face of the subject with the infrared representation of the face of the subject.

In Example 43, the subject matter of any one or more of Examples 36-42 optionally include, further comprising instruction to: access an audio portion of the source video, the audio portion including an audio recording of the human subject; and wherein the instruction to render the output video comprise instruction to replacing the audio portion of the source video with a modified audio portion to obscure the audio recording of the subject.

In Example 44, the subject matter of Example 43 optionally includes, wherein the modified audio portion is composed by altering a pitch of the audio recording of the human subject.

In Example 45, the subject matter of Example 44 optionally includes, wherein the pitch is randomly altered over time.

In Example 46, the subject matter of any one or more of Examples 36-45 optionally include, wherein the instruction to render the output video with the face and the areas of exposed skin obscured comprise instruction to alter the expressive avatar as the emotion exhibited by the face of the human subject changes in the source video.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A video processing system for obfuscating identity in visual images, the system comprising:
a data interface to access a source video having a human subject;
an emotion classifier to determine an emotion exhibited by a face of the human subject;
a skin classifier to detect areas of exposed skin of the human subject; and
a video rendering module to render an output video with the face and the areas of exposed skin obscured, the face obscured with an expressive avatar exhibiting an expression similar to the emotion exhibited by the human subject.

2. The system of claim 1, wherein to determine the emotion exhibited by the face, the emotion classifier is to:
identify a plurality of facial landmarks in the face;
access a facial emotion database; and
classify the emotion exhibited based on the plurality of facial landmarks and the facial emotion database.

3. The system of claim 1, wherein to detect areas of exposed skin, the skin classifier is to:
sample a portion of an image obtained from the source video; and
determine whether the portion of the image is skin or non-skin.

4. The system of claim 1, further comprising a hair classifier to:
detect head hair of the human subject; and
wherein to render the output video, the video rendering module is to obscure the head hair.

5. The system of claim 4, wherein to obscure the head hair, the video rendering module is to render the head hair in a solid color.

6. The system of claim 1, wherein the data interface is to access an infrared image of the human subject, the infrared image including an infrared representation of the areas of exposed skin of the subject; and
wherein to render the output video, the video rendering module is to render the areas of exposed skin with the infrared representation of the areas of exposed skin of the subject.

7. The system of claim 1, wherein to render the output video, the video rendering module is to render the face of the subject with the infrared representation of the face of the subject.

8. The system of claim 1, wherein the data interface is to access an audio portion of the source video, the audio portion including an audio recording of the human subject; and
wherein to render the output video, the video rendering module is to render the audio portion of the source video with a modified audio portion to obscure the audio recording of the subject.

9. The system of claim 8, wherein the modified audio portion is composed by altering a pitch of the audio recording of the human subject.

10. The system of claim 9, wherein the pitch is randomly altered over time.

11. The system of claim 1, wherein to render the output video with the face and the areas of exposed skin obscured, the video rendering module is to alter the expressive avatar as the emotion exhibited by the face of the human subject changes in the source video.

12. A method of obfuscating identity in visual images, the method comprising:
accessing, at a video processing system, a source video having a human subject;
determining an emotion exhibited by a face of the human subject;
detecting areas of exposed skin of the human subject; and
rendering an output video with the face and the areas of exposed skin obscured, the face obscured with an expressive avatar exhibiting an expression similar to the emotion exhibited by the human subject.

13. The method of claim 12, wherein determining the emotion exhibited by the face comprises:
identifying a plurality of facial landmarks in the face;
accessing a facial emotion database; and
classifying the emotion exhibited based on the plurality of facial landmarks and the facial emotion database.

14. The method of claim 12, wherein detecting areas of exposed skin comprises:
sampling a portion of an image obtained from the source video; and
using a skin classifier to determine whether the portion of the image is skin or non-skin.

15. The method of claim 12, further comprising:
detecting head hair of the human subject; and
wherein rendering the output video comprises obscuring the head hair.

16. The method of claim 15, wherein obscuring the head hair comprises rendering the head hair in a solid color.

17. The method of claim 12, further comprising:
accessing an infrared image of the human subject, the infrared image including an infrared representation of the areas of exposed skin of the subject; and
wherein rendering the output video comprises rendering the areas of exposed skin with the infrared representation of the areas of exposed skin of the subject.

18. The method of claim 12, wherein rendering the output video comprises rendering the face of the subject with the infrared representation of the face of the subject.

19. The method of claim 12, further comprising:
accessing an audio portion of the source video, the audio portion including an audio recording of the human subject; and
wherein rendering the output video comprises replacing the audio portion of the source video with a modified audio portion to obscure the audio recording of the subject.

20. The method of claim 19, wherein the modified audio portion is composed by altering a pitch of the audio recording of the human subject.

21. The method of claim 20, wherein the pitch is randomly altered over time.

22. The method of claim 12, wherein rendering the output video with the face and the areas of exposed skin obscured comprises altering the expressive avatar as the emotion exhibited by the face of the human subject changes in the source video.

23. A system for obfuscating identity in visual images, the system comprising:
a processor subsystem; and
a memory including instructions, which when executed by the processor subsystem, cause the processor subsystem to:
access a source video having a human subject;
determine an emotion exhibited by a face of the human subject;
detect areas of exposed skin of the human subject; and
render an output video with the face and the areas of exposed skin obscured, the face obscured with an expressive avatar exhibiting an expression similar to the emotion exhibited by the human subject.

24. The system of claim 23, wherein the instruction to determine the emotion exhibited by the face comprise instruction to:
identify a plurality of facial landmarks in the face;
access a facial emotion database; and
classify the emotion exhibited based on the plurality of facial landmarks and the facial emotion database.

25. The system of claim 23, further comprising instruction to:
access an infrared image of the human subject, the infrared image including an infrared representation of the areas of exposed skin of the subject; and
wherein the instruction to render the output video comprise instruction to rendering the areas of exposed skin with the infrared representation of the areas of exposed skin of the subject.
